(19) United States
(12) Patent Application Publication
(10) Pub. No.: US 2008/0292015 A1
(43) Pub. Date: Nov. 27, 2008

(54) Channel Estimation Method of Mobile Terminal in Wireless Communication System and Channel Estimator Employing the Method

(75) Inventor: Kang Min Lee, Gyeonggi (KR)

Correspondence Address: BLANK ROME LLP, 600 NEW HAMPSHIRE AVENUE, N.W., WASHINGTON, DC, 20037, US

(73) Assignee: POSTDATA, CO. LTD.

(21) Appl. No.: 12/159,451

(22) PCT Filed: Dec. 28, 2006
(86) PCT No.: PCT/KR2006/005803

§ 371 Date: Jun. 27, 2008

(30) Foreign Application Priority Data
Dec. 30, 2005 (KR) 10-2005-0135386

(51) Int. Cl. H04L 27/26

(52) U.S. Cl. 375/260

(57) ABSTRACT

Provided is a mobile terminal of a wireless communication system, and more particularly, a channel estimation method performed in a mobile terminal of a wireless communication system supporting the IEEE 802.16e standard and a channel estimator of the mobile terminal to which the method is applied. The channel estimation method includes the steps of: extracting a preamble included in a received signal and obtaining a preamble estimation value based on the preamble; extracting a pilot included in the received signal and obtaining a pilot estimation value based on the pilot; and obtaining a channel estimation value based on calculating the preamble estimation value and the pilot estimation value according to a predetermined algorithm.

### TECHNICAL FIELD

The present invention relates to a mobile terminal of a wireless communication system, and more particularly, to a channel estimation method performed in a mobile terminal of a wireless communication system supporting the Institute of Electrical and Electronics Engineers (IEEE) 802.16e standard and a channel estimator of the mobile terminal to which the method is applied.

### BACKGROUND ART

As is well-known to one of ordinary skill in the art, to perform channel estimation in a mobile terminal, training symbols previously defined between a transmitter and a receiver are required. In particular, the training symbols that can be used for systems based on the IEEE 802.16e standard or a downlink (DL) of a Wireless Broadband (WiBro) system that is one of the systems include preambles or pilots.

The preamble is transmitted through a first orthogonal frequency division multiple access (OFDMA) symbol of every DL frame. In addition, the pilot is transmitted through every OFDMA symbol of the DL frame except for the preamble. FIG. 1 illustrates an example of an OFDMA Time Division Duplex (TDD) frame structure of the WiBro system according to an exemplary embodiment of the present invention. The frame structure illustrated in FIG. 1 is based on the IEEE 802.16d/e standard.

Referring to FIG. 1, a preamble is assigned to a first symbol of the DL frame. This preamble is used for frame synchronization and cell classification.

A transmission/reception transition gap (TTG) is inserted between a downlink (DL) and an uplink (UL), and a reception/transmission transition gap (RTG) is inserted between an end of a frame and a start of another frame. Also, first four subchannels of two OFDMA symbols transmitted right after the preamble include a 24-bit Frame Control Header (FCH) for transmitting information on a frame. This DL frame may have a plurality of zones. Each of the zones is classified by an OFDMA subchannel allocation method and may vary according to each OFDMA symbol. The subchannel allocation method includes Partial Usage of Subchannels (PUSC), Full Usage of Subchannels (FUSC), Band-AMC methods, etc.

In the present invention, a channel estimation method and a channel estimator in which a conventional channel estimation method is more enhanced to thereby improve accuracy of the channel estimation in both time-variant channel environment and time-invariant channel environment are provided.

### DISCLOSURE OF INVENTION

### Technical Problem

The present invention is directed to a channel estimation method of a mobile terminal capable of enhancing accuracy of the channel estimation in both time-variant and time-invariant channel environments.

The present invention is also directed to a channel estimation method using a preamble together with a pilot to thereby perform more precise channel estimation.

The present invention is also directed to a channel estimation method in which an improved channel estimation method is provided to thereby enhance data reception performance of a mobile terminal.

The present invention is also directed to a channel estimation method having the advantages of both a channel estimation method using a preamble and a channel estimation method using a pilot so that both signal-to-noise ratio performance and bit-error-rate characteristics of a mobile terminal are improved.

The present invention is directed to a channel estimation method in which both signal-to-noise ratio performance and bit-error-rate characteristics of a mobile terminal are improved so that power consumed for data transmission of a base station is reduced, and thus inter-symbol interference is reduced to increase overall capacity of a system.

### Technical Solution

One aspect of the present invention provides a channel estimation method in a mobile terminal of a wireless communication system including the steps of: extracting a preamble included in a received signal and obtaining a preamble estimation value based on the preamble; extracting a pilot included in the received signal and obtaining a pilot estimation value based on the pilot; and obtaining a channel estimation value based on calculating the preamble estimation value and the pilot estimation value according to a predetermined algorithm

Another aspect of the present invention provides a channel estimator of a mobile terminal including: a preamble channel estimator for receiving a preamble extracted from a received signal and generating a preamble estimation value based on the preamble; a pilot channel estimator for receiving a pilot extracted from the received signal and generating a pilot estimation value based on the pilot; and a calculator for generating a channel estimation value based on calculating the preamble estimation value and the pilot estimation value.

### ADVANTAGEOUS EFFECTS

According to the channel estimation method and the channel estimator of the present invention, high-accuracy channel estimation may be realized in both time-variant and time-invariant channel environments.

According to the channel estimation method and the channel estimator of the present invention, more precise channel estimation can be performed since both the channel estimation using a pilot and the channel estimation using a preamble are carried out.

According to the channel estimation method and the channel estimator of the present invention, an improved channel estimation method is provided, so that data reception performance of a mobile terminal is enhanced.

According to the channel estimation method and the channel estimator of the present invention, since the channel estimation method has advantages of both the channel estimation using the preamble and the channel estimation using the pilot, signal-to-noise performance in addition to bit-error-rate characteristics of the mobile terminal are considerably increased.

According to the channel estimation method and the channel estimator of the present invention, since the signal-to-noise performance in addition to the bit-error-rate characteristics of the mobile terminal are considerably increased, power consumed for data transmission of a RAS is reduced, ISI thereof is also reduced, and overall capacity of a system is increased.

### BRIEF DESCRIPTION OF THE DRAWINGS

FIG. 1 illustrates a structure of an orthogonal frequency division multiple access (OFDMA) Time Division Duplex (TDD) frame based on the IEEE 802.16d/e standard according to an exemplary embodiment of the present invention;

FIG. 2 is a block diagram illustrating a configuration of a mobile terminal according to an exemplary embodiment of the present invention;

FIG. 3 is a block diagram illustrating a configuration of a channel estimator of the mobile terminal according to an exemplary embodiment of the present invention;

FIG. 4 is a flowchart illustrating a channel estimation method performed in the mobile terminal according to an exemplary embodiment of the present invention; and

FIG. 5 is a graph illustrating a relationship between weights generated by a weight generator of a channel estimator and an orthogonal frequency division multiple access (OFDMA)/Orthogonal Frequency Division Multiplexing (OFDM) symbol index according to an exemplary embodiment of the present invention.

### DESCRIPTION OF MAIN ELEMENTS APPEARING IN THE ABOVE FIGURES

310: Weight Generator
320: Pilot Channel Estimator
330: Preamble Channel Estimator

### MODE FOR THE INVENTION

In this specification, the terminology “communication terminal” refers to a portable electric/electronic device, including all kinds of handheld wireless communication devices, equipment having communication functions, portable terminals, and international mobile telecommunication (IMT)-2000 terminals. The equipment having communication functions includes personal digital cellular (PDC) phones, personal communication service (PCS) phones, code division multiple access (CDMA)-2000 (1X and 3X) phones, wideband CDMA (WCDMA) phones, dual band/dual mode phones, global standard for mobile (GSM) phones, mobile broadband system (MBS) phones, digital multimedia broadcasting (DMB) terminals, smart phones, orthogonal frequency division multiplexing (OFDM)/orthogonal frequency division multiple access (OFDMA) communication terminals, and so on. The portable terminals include personal digital assistants (PDAs), hand-held personal computers (PCs), notebook computers, laptop computers, wireless broadband Internet (WiBro) terminals, moving picture experts group layer 3 (MP3) players, and so on. And, the IMT-2000 terminals provide an international roaming service and an expanded mobile communication service. A communication terminal may have a predetermined communication module such as an OFDMA module, a CDMA module, a Bluetooth module, an infrared communication module, a wired/wireless local area network (LAN) card, and a wireless communication device equipped with a global positioning system (GPS) chip to enable positioning using a GPS system. Also, a communication terminal is equipped with a microprocessor capable of playing multimedia, thereby performing a specific operation.

Moreover, the “wireless communication system” mentioned in the present specification may be a system based on one of the IEEE 802.16d/e standard, the WiBro standard, and the WiMax standard.

A channel estimation method in a mobile terminal of a wireless communication system and a channel estimator according to the present invention will be described below in detail with reference to the accompanying drawings.

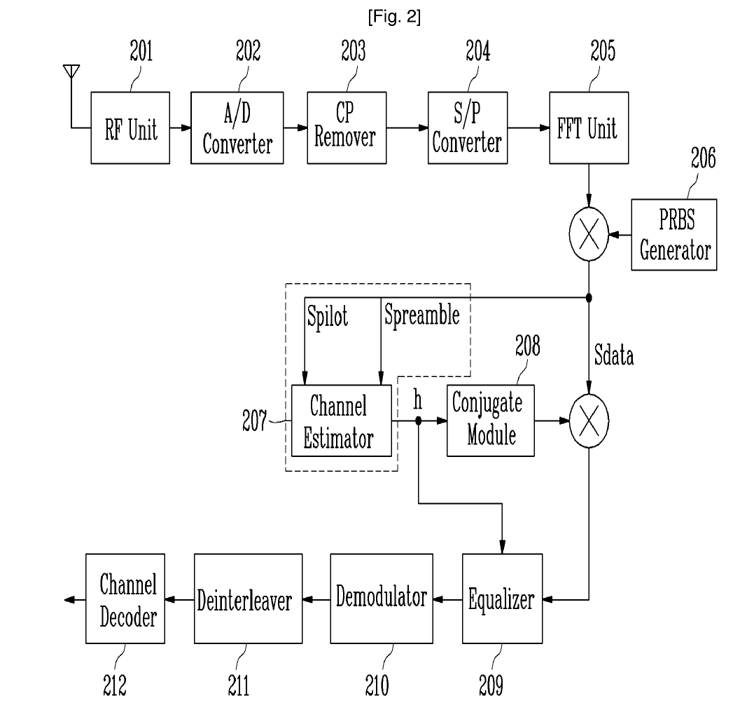

FIG. 2 is a block diagram illustrating a configuration of a mobile terminal according to an exemplary embodiment of the present invention.

Referring to FIG. 2, the mobile terminal according to an exemplary embodiment of the present invention may include the following modules.

A radio frequency (RF) signal received by an antenna of the mobile terminal is converted into an analog baseband signal via an RF unit 201. The analog baseband signal is quantized by an A/D converter 202. The quantized received signal is Fourier-transformed by a Fast Fourier Transform (FFT) unit 205 through a cyclic prefix (CP) remover 203 and a serial/parallel (S/P) converter 204.

The CP remover 203 removes a cyclic prefix (CP) added to the received signal. The CP acts as a guard interval for preventing inter-symbol interference (ISI) in an OFDMA/OFDM symbol. After the CP that is a kind of overhead is removed, the received signal where the CP is removed is input into the S/P converter 204.

The S/P converter 204 converts the received signal that is serially input into parallel received signals numbering the same as sub-carriers.

A Pseudo Random Binary Sequence (PRBS) generator 206 generates the same PRBS as the PRBS that is multiplied when the corresponding reception signal is transmitted from a base station. Then, the Fourier-transformed reception signal is multiplied by the generated PRBS to thereby remove the PRBS from the reception signal. Pilots and preambles of the reception signal where the PRBS is removed are input into a channel estimator 207.

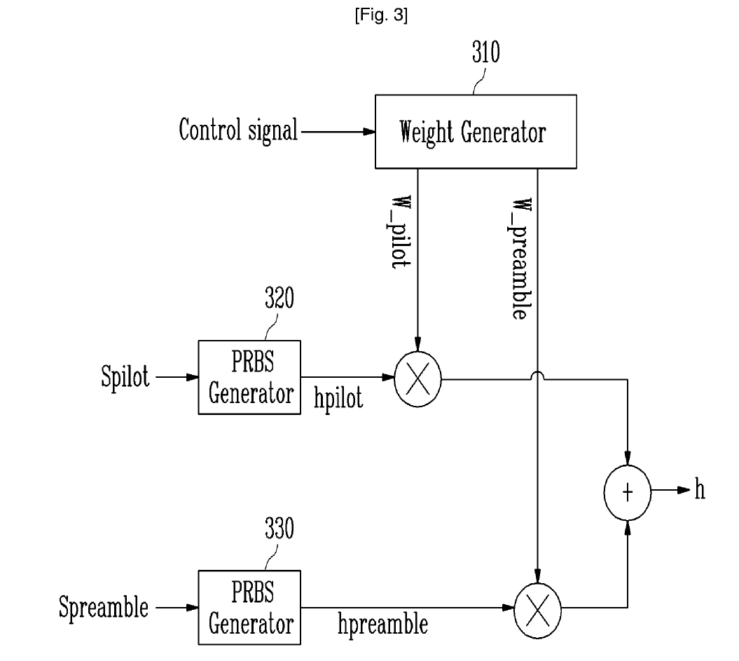

The channel estimator 207 according to the present invention will be described in detail with reference to FIG. 3.

FIG. 3 is a block diagram illustrating a configuration of the channel estimator of the mobile terminal according to an exemplary embodiment of the present invention.

As is well-known to one of ordinary skill in the art, since transmission power level of the preamble is about 6 to 7 dB higher than that of the pilot, the channel estimation using the preamble may have a higher accuracy than the channel estimation using the pilot. However, considering mobility of the mobile terminal supported by the wireless communication system (e.g., WiBro system), when the mobile terminal is in a time-variant channel environment, the accuracy of the channel estimation using the preamble may deteriorate with respect to the OFDMA/OFDM symbol that is transmitted after the preamble in the same DL frame. Also, the channel estimation using the pilot has advantages and disadvantages that are exactly reverse of those for the channel estimation using the preamble. Therefore, the channel estimator of the mobile terminal illustrated in FIG. 3 according to an exemplary embodiment of the present invention provides a channel estimation structure using both the preamble and the pilot.

Referring to FIG. 3, the channel estimator according to the present invention may include a pilot channel estimator 320, a preamble channel estimator 330, a weight generator 310, a multiplier for multiplying signals generated by each module, and an adder for adding the signals. While in FIG. 3, the pilot channel estimator 320 is illustrated as a separate module from the preamble channel estimator 330, the two components are functionally separated from each other for the sake of simplicity and they may be physically incorporated into one or more channel estimators or separated from each other when substantially implemented.

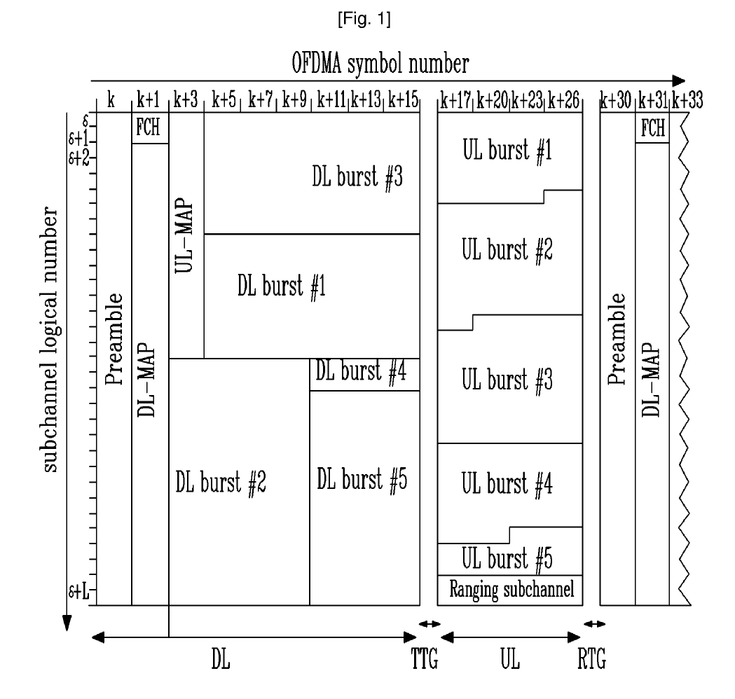

As illustrated in FIG. 1, when the DL frame is configured as a two-dimensional plane including a time axis (an OFDMA symbol axis) and a frequency axis (a sub-carrier axis), one preamble may be transmitted per three sub-carriers within a first OFDMA/OFDM symbol of the DL frame. Also, the pilot is transmitted in every frequency band in which the base station occupies at a predetermined interval within all OFDMA/OFDM symbols except for the preamble. The location of the frequency axis where the pilot is transmitted varies depending on a channel mode such as a Downlink Partial Usage of Subchannels (DL PUSC) mode, a Downlink Full Usage of Subchannels (DL FUSC) mode, a DL Band-AMC mode, etc.

The preamble channel estimator performs one-dimensional interpolation on the received preamble S_{preamble} with respect to the frequency axis (the sub-carrier axis) to thereby generate a preamble estimation value h_{preamble}.

Also, the pilot channel estimator performs two-dimensional interpolation on the received pilot Sₚᵢₗₒₜ with respect to the time axis (the ODFMA OFDM symbol axis) and the frequency axis (the sub-carrier axis) to thereby generate a pilot estimation value hₚᵢₗₒₜ.

As is well-known to one of ordinary in the art, when it is assumed that the two components that are objects of interpolation are A and B, weight factors for each component are a and b, and a value obtained as a result of the interpolation using A and B is C, then C=aA+bB (0<a<1, 0<b<1, a+b=1).

The interpolation method may include linear interpolation, secondary interpolation, cubic spline interpolation, interpolation using a lowpass filter, etc. In addition, the interpolation method may be adequately selected depending on requirements of a system, allocation of symbols according to different channels, etc.

The weight generator 310 generates weights that are applied to the preamble estimation value h_{preamble} generated by the preamble channel estimator 330 and the pilot estimation value hₚᵢₗₒₜ generated by the pilot channel estimator 320. According to an exemplary embodiment of the present invention, a preamble weight W_preamble applied to the preamble estimation value h_{preamble} may be relatively highly generated with respect to a symbol relatively close to the preamble. A sum of the preamble weight W_preamble and the pilot weight W_pilot is one (1).

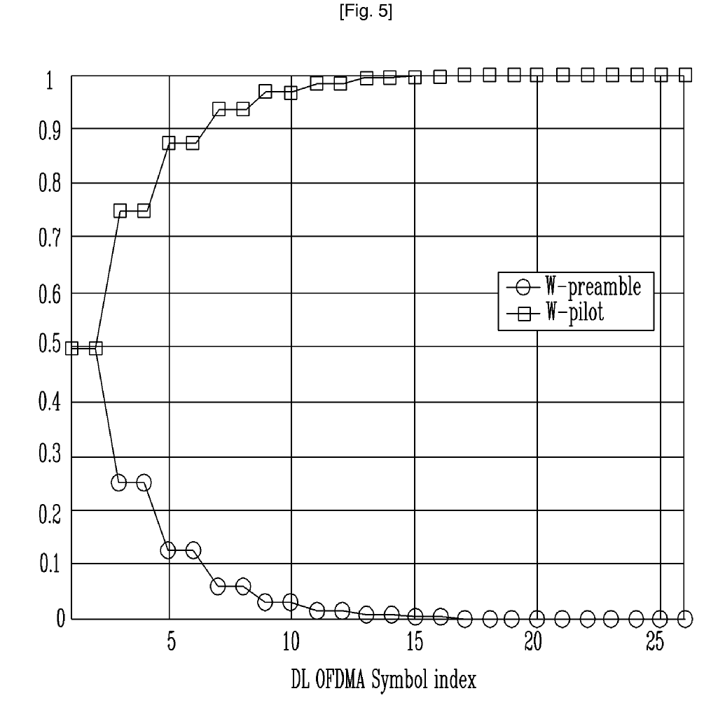

In the weight generator 310, a control signal for generating the preamble weight W_preamble and the pilot weight W_pilot is input to the weight generator. This control signal may be an OFDMA/OFDM symbol index that shows distance information between the corresponding symbol and the preamble. The weight generator 310 that receives the OFDMA/OFDM symbol index as a control signal may generate the preamble weight W_preamble and the pilot weight W_pilot according to the distance between the preamble and the corresponding symbol. A change in the preamble weight W_preamble and the pilot weight W_pilot with respect to the OFDMA/OFDM symbol index is illustrated in FIG. 5 in detail. Referring to FIG. 5, as the OFDMA/OFDM symbol index increases, the preamble weight W_preamble is reduced and the pilot weight W_pilot is increased. The weight generator according to the present invention, for example, may generate the preamble weight W_preamble according to the following equation. Also, the pilot weight W_pilot may be generated by subtracting the preamble weight W_preamble calculated by Equation 1 from one (1).

$$Preamble Weight = \frac{1}{2 [ \frac{Symbol Index + 1}{2} ]} \qquad ( Equation 1 )$$

As represented by Equation 1, as the OFDMA/OFDM symbol index increases, the preamble weight W_preamble is reduced, and reversely, the pilot weight W_pilot is increased. In the symbol index of Equation 1, the OFDMA/OFDM symbol index during which preamble is transmitted is zero (0).

The multiplier multiplies the preamble estimation value h_{preamble} generated by the preamble channel estimator 330 by the preamble weight W_preamble generated by the weight generator 310 to thereby generate a first channel estimation value. In addition, the multiplier multiplies the pilot estimation value hₚᵢₗₒₜ generated by the pilot channel estimator 320 by the pilot weight W_pilot generated by the weight generator 310 to thereby generate a second channel estimation value.

The adder adds the first channel estimation value and the second channel estimation value to thereby generate a final channel estimation value. The channel estimation value generated by the adder is input to a conjugate module 208 and an equalizer 209 illustrated in FIG. 2, and is used for demodulation of received data.

For example, with respect to a symbol relatively close to the preamble, the channel estimation value may be generated as represented in Equation 2.

$${h}_{1} = {h}_{preamble} \cdot \frac{1}{4} + {h}_{pilot} \cdot \frac{3}{4} \qquad ( Equation 2 )$$

Also, with respect to a symbol relatively far from the preamble, the channel estimation value may be generated as represented in Equation 3.

$${h}_{2} = {h}_{preamble} \cdot \frac{1}{8} + {h}_{pilot} \cdot \frac{7}{8} \qquad ( Equation 3 )$$

As represented by Equations 2 and 3, the symbol relatively close to the preamble may be more influenced by the preamble weight W_preamble than that relatively far from the preamble.

Equations 1 to 3 are given as examples, and one of ordinary skill in the art could have easily understood that the channel estimator according to the present invention may vary in various forms that can be implemented.

Referring again to FIG. 2, the channel estimation value generated by the channel estimator 207 according to the present invention is input to the conjugate module 208. The conjugate module 208 takes conjugation of the channel estimation value output from the channel estimator 207. The conjugation of the channel estimation value is multiplied by payload data of the reception signal where the PRBS is removed. According to this process, a channel where the reception signal is transmitted is compensated. The reception signal of the compensated channel is equalized by the equalizer 209, and the equalized reception signal is demodulated by a demodulator 210. The demodulated reception signal is deinterleaved by a deinterleaver 211, and a channel decoder 212 finally performs channel decoding.

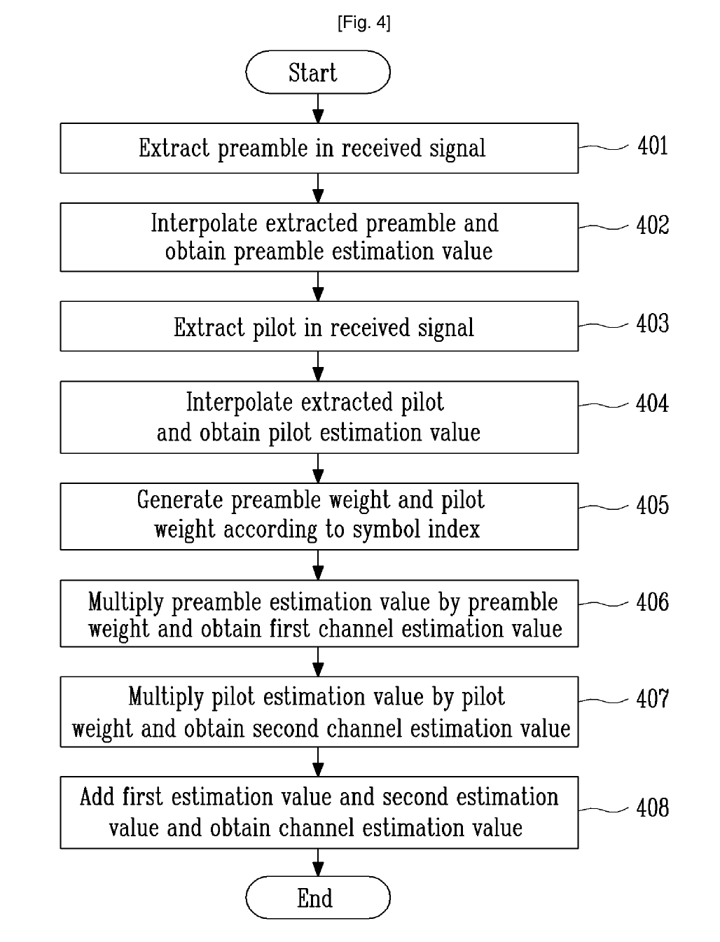

FIG. 4 is a flowchart illustrating a channel estimation method performed in a mobile terminal according to an exemplary embodiment of the present invention.

Referring to FIG. 4, the channel estimation method of the mobile terminal according to the present invention may include the following steps. As is well-known to one of ordinary skill in the art, the flowchart illustrated in FIG. 4 is only one example for describing the present invention, and the steps described below should not be understood as longitudinal steps. For example, the step of obtaining a preamble estimation value using a preamble and the step of obtaining a pilot estimation value using a pilot may be simultaneously performed or a specific step may be performed first.

The PRBS generated by the PRBS generator 206 illustrated in FIG. 2 is multiplied by the received signal to thereby remove the PRBS of the received signal. Then, the received signal where the PRBS is removed is input to a channel estimator according to the present invention.

A preamble is extracted from the received signal input to the channel estimator (step 401). Afterwards, one-dimensional interpolation is performed on the extracted preamble with respect to a frequency axis (a sub-carrier axis) to thereby obtain a preamble estimation value (step 402).

A pilot is extracted from the received signal that is input to the channel estimator (step 403). Afterwards, two-dimensional interpolation is performed on the extracted pilot with respect to a time axis (an OFDMA symbol axis) and the frequency axis (the sub-carrier axis) to thereby obtain a pilot estimation value (step 404).

The weight generator according to the present invention generates weights that are applied to the preamble estimation value generated by the preamble channel estimator and the pilot estimation value generated by the pilot channel estimator (step 405). As described in FIG. 3, the preamble weight that is applied to the preamble estimation value may be relatively highly generated with respect to a symbol relatively close to the preamble. A sum of the preamble weight and the pilot weight is one (1). In step 405, a control signal for generating the preamble weight and the pilot weight is input to the weight generator. This control signal may be an OFDMA/OFDM symbol index that indicates distance information between the corresponding symbol and the preamble. The weight generator that receives the OFDMA/OFDM symbol index as the control signal may generate the preamble weight and the pilot weight according to the distance between the preamble and the corresponding symbol. As described above, a change in the preamble weight W_preamble and the pilot weight W_pilot with respect to the OFDMA/OFDM symbol index is illustrated in FIG. 5 in detail. Referring to FIG. 5, as the OFDMA/OFDM symbol index increases, the preamble weight W_preamble is gradually reduced and the pilot weight W_pilot is increased.

Next, the preamble estimation value generated by the preamble channel estimator is multiplied by the preamble weight generated by the weight generator to thereby generate a first channel estimation value (step 406). In addition, the pilot estimation value generated by the pilot channel estimator is multiplied by the pilot weight generated by the weight generator to thereby generate a second channel estimation value (step 407).

Finally, the first channel estimation value and the second channel estimation value that are obtained in steps 406 and 407 are added to each other to thereby generate a final channel estimation value (step 408). The channel estimation value obtained in step 408 is input to the conjugate module 208 and the equalizer 209 described in FIG. 2, and is used for demodulation of received data.

The channel estimation method of the mobile terminal according to the present invention may be implemented in the form of program instructions that can be executed through various computer means to be recorded on computer readable media. The computer readable media may individually include program instructions, data files, data structures, etc., or may include a combination of the media. The program instructions recorded on the media may be particularly designed for the present invention or would have been well-known to one of ordinary skill in the art of software. The computer readable recording media include magnetic media, optical media, magnetooptical media and a hardware device. The magnetic media include a hard disk, a floppy disk, and a magnetic tape. The optical media include CD-ROM, and DVD. The magneto-optical media include a floptical disk. The hardware device for recording and executing the program instructions include ROM, RAM, a flash memory, etc. The media may be transmission media such as a metal wire, a waveguide, or light including a sub-carrier transmitting a signal designating program instructions, data structures, etc. The program instructions include not only machine codes generated by a compiler, but high-level language codes executed by a computer using an interpreter, etc. The hardware device may operate using one or more software modules for executing operations of the present invention, and vice versa.

While the invention has been shown and described with reference to certain exemplary embodiments thereof, it will be understood by those skilled in the art that various changes in form and details may be made therein without departing from the spirit and scope of the invention as defined by the appended claims.

1. A channel estimation method of a mobile terminal, comprising the steps of:
extracting a preamble included in a received signal and obtaining a preamble estimation value based on the preamble;
extracting a pilot included in the received signal and obtaining a pilot estimation value based on the pilot; and
obtaining a channel estimation value based on calculating the preamble estimation value and the pilot estimation value according to a predetermined algorithm.

2. The channel estimation method of claim 1, wherein in the step of obtaining the preamble estimation value, one-dimensional interpolation is performed on the preamble with respect to a frequency axis.

3. The channel estimation method of claim 1, wherein in the step of obtaining the pilot estimation value, two-dimensional interpolation is performed on the pilot with respect to a frequency axis and a symbol index axis.

4. The channel estimation method of claim 1, wherein the step of obtaining the channel estimation value comprises the steps of:
generating a first channel estimation value by multiplying a preamble weight by the preamble estimation value;
generating a second channel estimation value by multiplying a pilot weight by the pilot estimation value; and
adding the first channel estimation value and the second channel estimation value to obtain the channel estimation value.

5. The channel estimation method of claim 4, wherein the preamble weight and the pilot weight are generated according to a symbol index.

6. The channel estimation method of claim 4, wherein in the step of generating the preamble weight and the pilot weight, the preamble weight is in inverse proportion to a distance between the preamble and the symbol.

7. The channel estimation method of claim 1, wherein the channel is a downlink channel used for one of a Downlink (DL) Partial Usage of Subchannels (DL-PUSC), a DL Full Usage of Subchannels (FUSC), a DL-PUSC with all Subchannels, an optional FUSC, a Band-AMC, a DL Tile Usage of Subchannels (TUSC) 1, and a DL-TUSC 2.

8. A channel estimation method of a mobile terminal supporting an OFDM/OFDMA scheme, comprising the steps of:
receiving a Down Link signal;
extracting a preamble and a pilot included in the Down Link signal; and
obtaining a channel estimation value using the preamble and the pilot.

9. The channel estimation method of claim 8, wherein the step of obtaining the channel estimation value using the preamble and the pilot comprises the steps of:
generating a first channel estimation value by multiplying a preamble weight by a preamble estimation value;
generating a second channel estimation value by multiplying a pilot weight by a pilot estimation value; and
adding the first channel estimation value and the second channel estimation value to obtain the channel estimation value.

10. A computer readable recording medium for recording programs for executing the method of claim 1.

11. A channel estimator of a mobile terminal, comprising:
a preamble channel estimator for receiving a preamble extracted from a received signal and generating a preamble estimation value based on the preamble;
a pilot channel estimator for receiving a pilot extracted from the received signal and generating a pilot estimation value based on the pilot; and
a calculator for generating a channel estimation value based on calculating the preamble estimation value and the pilot estimation value.

12. The channel estimator of claim 11, wherein the preamble channel estimator performs one-dimensional interpolation on the preamble with respect to a frequency axis.

13. The channel estimator of claim 11, wherein the pilot channel estimator performs two-dimensional interpolation on the pilot with respect to the frequency axis and a symbol index axis.

14. The channel estimator of claim 11, wherein the calculator comprises:
a first multiplier for multiplying a preamble weight by the preamble estimation value to generate a first channel estimation value;
a second multiplier for multiplying a pilot weight by the pilot estimation value to generate a second channel estimation value; and
an adder for adding the first channel estimation value and the second channel estimation value to generate the channel estimation value.

15. The channel estimator of claim 14, further comprising a weight generator for generating the preamble weight and the pilot weight, wherein the preamble weight and the pilot weight are generated according to a symbol index.

16. The channel estimator of claim 14, wherein the preamble weight generated by the weight generator is in inverse proportion to a distance between the preamble and the symbol.

17. The channel estimator of claim 11, wherein the channel is a downlink channel used for one of a DL PUSC, a DL FUSC, a DL PUSC with all Subchannels, an optional FUSC, a Band-AMC, a DL TUSC 1, and a DL TUSC 2.

18. A mobile terminal supporting an OFDMA/OFDM scheme, comprising:
a receiving terminal for receiving a downlink signal; and
a channel estimator for extracting a preamble and a pilot included in the downlink signal, and generating a channel estimation value using the preamble and the pilot.

19. The mobile terminal of claim 18, wherein the channel estimator comprises:
a preamble channel estimator for generating a preamble estimation value based on the preamble;
a pilot channel estimator for generating a pilot estimation value based on the pilot; and a calculator for generating the channel estimation value based on the preamble estimation value and the pilot estimation value.
